(19) United States
(12) Patent Application Publication
(10) Pub. No.: US 2025/0097340 A1
(43) Pub. Date: Mar. 20, 2025

(54) DO NOT DISTURB FOR ENCODED INFORMATION

(71) Applicant: Motorola Mobility LLC, Chicago, IL (US)

(72) Inventors: Krishnan Raghavan, Bangalore (IN); Nakul Patel, Bangalore (IN); Vignesh Karthik Mohan, Bangalore (IN)

(73) Assignee: Motorola Mobility LLC, Chicago, IL (US)

(21) Appl. No.: 18/369,016

(22) Filed: Sep. 15, 2023

(51) Int. Cl. H04M 1/72463; G06Q 20/22; G06Q 20/32

(52) U.S. Cl. CPC H04M 1/72463; G06Q 20/223; G06Q 20/326; G06Q 20/3274

(57) ABSTRACT

In aspects of Do Not Disturb for encoded information, a mobile device detects that encoded account information is generated for display on a screen of the mobile device. The mobile device activates a Do Not Disturb setting of the mobile device based on detecting that the encoded account information is generated for display and a determination by the mobile device that the Do Not Disturb setting is off. The mobile device detects dismissal of the encoded account information from display. And the mobile device deactivates the Do Not Disturb setting based on the dismissal of the encoded account information.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without risks. Financial technology applications are part of the broader context of online financial services, where financial services are provided over the Internet. Financial technology applications provide the ability for users to access financial data through Internet-connected computing devices such as mobile phones, tablets, laptops, desktop, and automated teller machines (ATMs). The shift from traditional financial services to digital financial technologies has been gradual and remains ongoing and is constituted by differing degrees of financial service digitization. Financial technology applications offer varying levels of process automation and web-based services. Financial technology applications include application programing interfaces (APIs) that enable cross-institutional services that provide financial products and transactions worldwide, any day of the week, at any time of day. For instance, when trying to use a financial application for a transaction (like receiving a payment) via a peer-to-peer payment system, user may inadvertently end up sharing or exposing a personal piece of information that wasn't intended for the other party.

### BRIEF DESCRIPTION OF THE DRAWINGS

Implementations of the techniques for Do Not Disturb for encoded information are described with reference to the following Figures. The same numbers may be used throughout to reference like features and components shown in the Figures.

FIG. 1 illustrates an example system for Do Not Disturb for encoded information in accordance with one or more implementations as described herein.

FIG. 2 further illustrates an example of Do Not Disturb for encoded information in accordance with one or more implementations as described herein.

FIGS. 3-5 illustrate example methods for Do Not Disturb for encoded information in accordance with one or more implementations of the techniques described herein.

FIG. 6 illustrates various components of an example device that may be used to implement the techniques for Do Not Disturb for encoded information as described herein.

### DETAILED DESCRIPTION

Implementations of the techniques for Do Not Disturb for encoded information may be implemented as described herein. A mobile device may be configured to perform techniques for Do Not Disturb for encoded information as described herein. In some cases, at least one mobile device implements an instantiation of a privacy controller, enabling the privacy protection functionality described herein. As described herein a mobile device can be implemented in a variety of different ways such as any type of a wireless device, mobile device, mobile phone, flip phone, client device, wearable computing device, tablet, computing device, communication device, entertainment device, gaming device, media playback device, and/or any other type of computing and/or electronic device, or a system of any combination of such devices,

With the advent of financial technology applications on mobile devices, users are able to receive a payment from another user based on a graphical code such as a quick response (QR) code, or a barcode, etc. The user who wants to receive the payment displays the graphical code (such as a QR code) on the screen of their mobile phone. The graphical code (such as a QR code) includes transaction information such as bank account information, amount to be paid, payment remarks, username, user email, etc. The payer scans the code using a camera function of a payment application on their mobile phone and completes the transaction after scanning the code.

However, at times showing the recipient device screen to the other party may present concerns with privacy and/or distraction. For example, if the recipient's device receives a private or confidential notification just as the payer is looking at the screen of the recipient's device to scan and pay, privacy issues arise when private information is displayed on the recipient's device in addition to the code. For example, private notifications appearing on the screen of the recipient's device when the code is being displayed results in potential breaches of privacy. Such notifications can reveal a user's sensitive personal information such as personal identity, social status, financial information, or put them in socially embarrassing situations. Also, such notifications can present a security risk when the notifications reveal confidential information. Examples of such notifications can include a salary deposit notification, a personal message, a government service notification, etc.

Do Not Disturb is a feature of some electronic devices (e.g., mobile devices, smartphones, tablet computers, laptops, etc.) that, when activated, blocks or suppresses notifications, messages, sounds, vibrations, and the like from appearing or occurring on the electronic device. Users that are receiving a payment typically do not turn on Do Not Disturb (or similar privacy mode) on their mobile device since the scan and pay operation is likely to take a relatively short time. Recipients often do not realize that any embarrassing or personal can pop up just as the payer is looking at the screen of the recipient's device. Other users who understand this issue and do not intend to take such risk, often turn off their notifications (or privacy mode such as Do Not Disturb) before the QR code is generated. However, such users can forget to turn off the Do Not Disturb setting after the scan and pay operation is completed. Also, being a manual process, it is tedious for such users to remember and manually turn on Do Not Disturb (or similar privacy mode) every time just before receiving a payment. In addition, turning on Do Not Disturb manually takes time and makes the payer wait longer. Such delays are contrary to quick operation intended for such digital payment transactions. Also, turning off Do Not Disturb, when a user remembers to turn it off, is another manual process that takes additional time to perform after the scan and pay operation. And when the user forgets to turn off Do Not Disturb after the payment is complete, the user can miss important notifications.

In an illustrative example, an individual is owed a debt by a colleague. In this scenario, the individual choses to show a payment QR code associated with the payment details on their mobile communication device screen. In an unforeseen synchronous occurrence, the individual receives a notification concerning the deposit of their monthly salary to their financial account. This notification is promptly displayed on the device display, disclosing both the sum of renumeration and the aggregate balance within their bank account. Consequently, this inadvertent disclosure of personal financial data, which was originally intended to remain confidential, becomes exposed to the colleague who is the payer in this transaction. This inadvertent exposure of personal financial information, beyond potentially eliciting feelings of discomfort, has the potential to impart distress upon the recipient, impacting their personal and professional spheres. Such occurrences underscore the significance of safeguarding the privacy and confidentiality of individuals' financial data within the realm of digital transactions.

In another scenario, an individual wishes to receive payment from a friend using a payment QR during a restaurant visit. To ensure the privacy, the individual activates the Do Not Disturb mode before showing the QR code. This causes a delay that confuses the friend. After the friend makes the payment, the individual realizes that they have not received the credit notification, which is usually instant. This leads to the individual having to check the statement manually on their app to confirm the payment. Upon returning home, the individual faces complaints from their spouse about the calls being unanswered. It then dawns upon them that they had missed deactivating the Do Not Disturb mode post the payment. This also explains the missed payment credit notification and unanswered calls. These examples highlight the risk of privacy breaches and disruptions when sharing the device screen during the financial transactions. Furthermore, even when users judiciously implement privacy settings, such as the Do Not Disturb mode, there is risk of overlooking to revert the Do Not Disturb mode, thus emphasizing the need for improved privacy solution.

In aspects of the described techniques, a privacy controller implements privacy protection functionality to protect user privacy seamlessly while a user is showing their device to others while receiving payments based on display of a payment code (such as a QR code). In one or more examples, the privacy protection functionality is performed via at least one mobile device that implements an instantiation of a privacy controller. The privacy controller proactively sets the Do Not Disturb mode of a payee device while it shows a QR code to receive payment and reverts the Do Not Disturb mode back to its previous state after the operation is completed.

When a payment code (such as a QR code) is generated to receive a payment, the privacy controller determines that the payment code (such as a QR code) is to be displayed on the screen for scanning. Hence, as the QR code is generated and being shown on the device's screen, the privacy controller automatically activates the Do Not Disturb mode on the device while displaying the payment code (QR code) on the screen. After the privacy controller detects that the QR code is dismissed, the privacy controller deactivates Do Not Disturb.

In one or more examples, the privacy controller detects generation of a payment code (such as a QR). For example, the privacy controller detects that the QR code is generated by a payment application (e.g., financial technology application), that the QR code is for receiving a payment, and/or that the QR code is for display on the mobile device. When the privacy controller detects the generation of the QR code, the privacy controller determines whether the current mode of the mobile device is Do Not Disturb or not. When the privacy controller determines that Do Not Disturb is set to OFF, the privacy controller saves the current settings (e.g., records Do Not Disturb is OFF based on the QR code being generated).

When the privacy controller determines that Do Not Disturb is set to OFF, the privacy controller automatically switches the Do Not Disturb mode to ON to ensure there are no interruptions or confidential notifications on the screen when the QR code is displayed on the mobile device. Thus, the payer scans the QR code and completes the payment without any breach of privacy and without disruptions. At some point, the privacy controller detects the end of the payment operation or end of the transaction. For example, the privacy controller detects the end of the payment operation based on a dismissal of the QR code, a minimizing of the QR code, a closing of a window that is displaying the QR code, a closing of an application that generated and/or displayed the QR code, the mobile phone being turned off, a lock screen on the mobile device, and the like. When the privacy controller detects the end of the operation, the privacy controller reverts to the saved settings. For example, the privacy controller restores the mobile device to its configuration before the QR code was displayed (e.g., reverts back to Do Not Disturb to deactivated state).

The privacy protection functionality of the privacy controller provides multiple advantages. For example, the privacy protection functionality protects a person's privacy when the person is showing a payment code (such as a QR code) on the screen of their mobile device to another person. The privacy protection functionality thus can mitigate the exposure of confidential information to other persons and can avoid potentially awkward and/or embarrassing situations by automatically controlling the Do Not Disturb mode. The privacy protection functionality saves users time by automatically activating and automatically deactivating the Do Not Disturb mode of their mobile device in relation to the displaying of the payment code (such as a QR code). The privacy protection functionality avoids a payer having to wait to see the QR code while a user manually activates Do Not Disturb before showing a QR code. The privacy protection functionality ensures that a user does not miss notifications after displaying the QR code.

While features and concepts of the described techniques for Do Not Disturb for encoded information are implemented in any number of different mobile devices, systems, environments, and/or configurations, implementations of the techniques for Do Not Disturb for encoded information are described in the context of following example devices, systems, and methods.

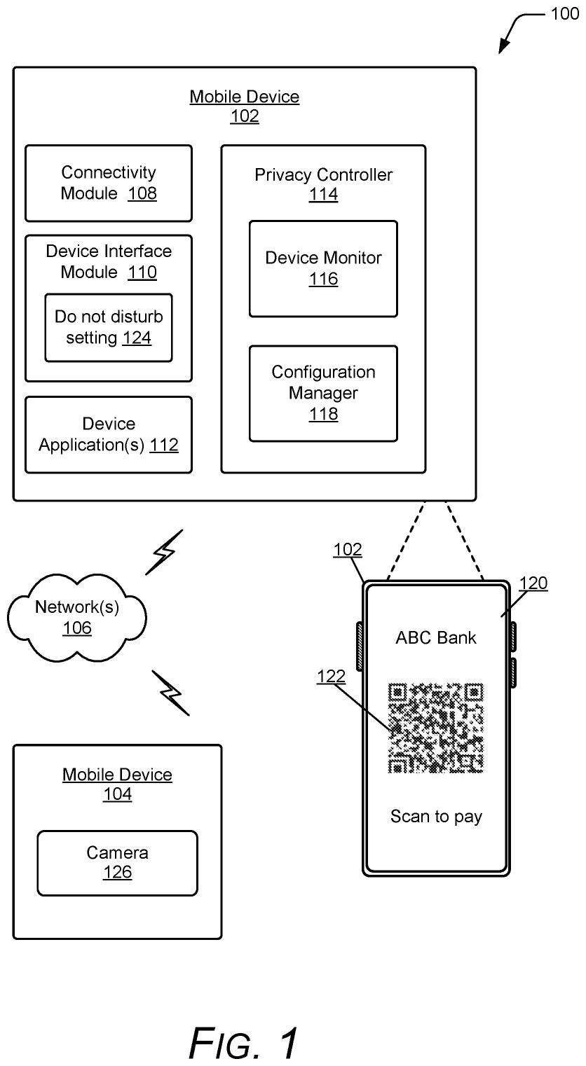

FIG. 1 illustrates an example system 100 for Do Not Disturb for encoded information, as described herein. The system 100 includes one or more mobile devices, such as a mobile device 102 and/or a mobile device 104. Examples of mobile devices include at least one of any type of a wireless device, mobile device, mobile phone, flip phone, client device, wearable computing device, camera device, display device, tablet, computing device, communication device, entertainment device, gaming device, media playback device, any other type of computing and/or electronic device, and/or a system of any combination of such devices.

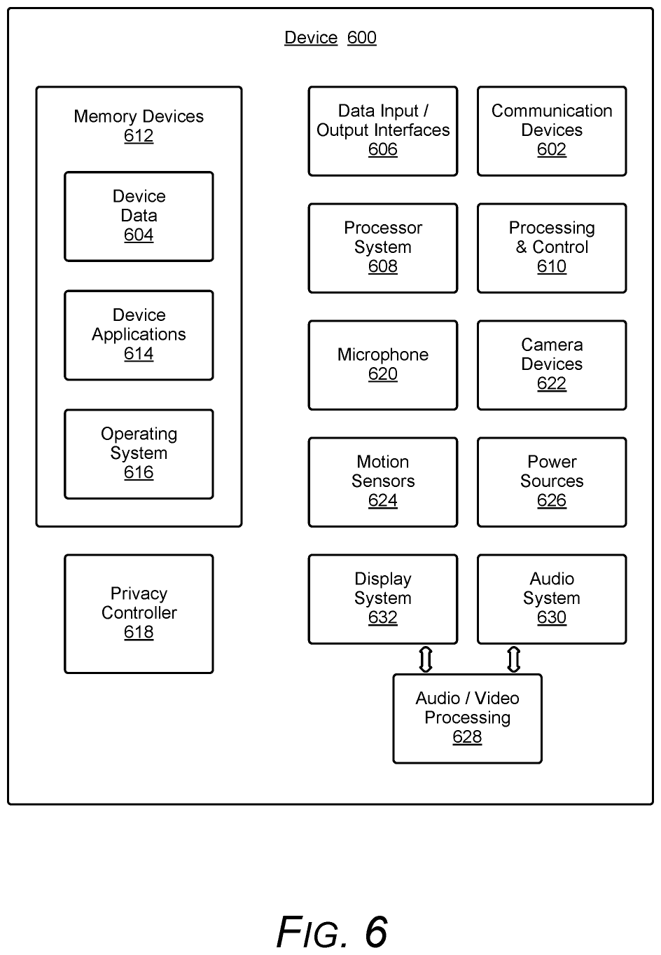

The mobile device 102 and/or the mobile device 104 is implemented with various components, such as a processor system and memory, as well as any number and combination of different components as further described with reference to the example device shown in FIG. 6. In implementations, the mobile device 102 includes various radios for wireless communication with other devices. In one or more examples, the mobile device 102 includes at least one of a BLUETOOTH® (BT) or BLUETOOTH® Low Energy (BLE) transceiver, a near field communication (NFC) transceiver, or the like. In some cases, the mobile device 102 includes at least one of a WI-FI® radio, a cellular radio, a global positioning satellite (GPS) radio, or any available type of device communication interface.

Additionally, or alternatively, the system 100 includes a mobile device 104, such as any type of computer, laptop device, desktop computer, tablet, wireless device, smart device, mobile device, display device, smart TV, or any other type of presentation device. Similar to the mobile device 102, the mobile device 104 is implemented with various components, such as a processor system and memory, as well as any number and combination of the different components as further described with reference to the example device shown in FIG. 6. In implementations, the mobile device 102 can be communicatively linked, either by a wired or wireless connection, to the mobile device 104. For example, the mobile device 102 and the mobile device 104 are communicatively linked via a communication network 106. Additionally or alternatively, the mobile device 102 and the mobile device 104 may be on different communication networks.

In some implementations, the devices, applications, modules, servers, and/or services described herein communicate via the communication network 106, such as for data communication between the mobile device 102 and the mobile device 104. The communication network 106 includes a wired and/or a wireless network. The communication network 106 is implemented using any type of network topology and/or communication protocol and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 includes various functionalities that enable the device to implement different aspects of Do Not Disturb for encoded information, as described herein. Similarly, the mobile device 104 includes various functionality that enables the computing device to implement different aspects of Do Not Disturb for encoded information, as described herein.

In the illustrated example, the mobile device 102 includes a connectivity module 108, a device interface module 110, device applications 112, and a privacy controller 114. The connectivity module 108 represents functionality (e.g., logic, software, and/or hardware) enabling the mobile device 102 to interconnect with other devices and/or networks, such as the mobile device 104 and the communication network 106. For example, the connectivity module 108 enables wireless and/or wired connectivity of the mobile device 102. The device interface module 110 represents functionality enabling the mobile device 102 to interface with other devices. As further detailed below, the device interface module 110 includes one or more device settings and/or device configurations of the mobile device 102. In the illustrated example, the device interface module 110 includes a Do Not Disturb setting 124 of the mobile device 102.

In one or more implementations, the mobile device 102 and/or the mobile device 104 include and implement device applications 112, such as any type of financial technology application, payment application, photo application, QR generating and/or encoding application, QR scanning and/or decoding application, messaging application, email application, video communication application, cellular communication application, music/audio application, gaming application, media application, social platform application, and/or any other of the many possible types of device applications. Many of the device applications 112 have an associated application user interface that is generated and displayed for user interaction and viewing (e.g., viewing of QR codes), such as on a display of the mobile device 102 and/or on a display of the mobile device 104. Generally, an application user interface, or any other type of video, image, graphic, graphical code (e.g., QR code), and the like is digital image content that is displayable on the display of the mobile device 102 and/or on the display of the mobile device 104.

In the example system 100 for Do Not Disturb for encoded information, the mobile device 102 and the mobile device 104 are mobile devices that incorporate privacy protection functionality. At least one of the mobile device 102 or the mobile device 104 implements an instantiation of a privacy controller 114 (e.g., as a device application 112). The privacy controller 114 represents functionality (e.g., logic, software, and/or hardware) enabling implementation of described techniques for Do Not Disturb for encoded information. In one or more examples, the privacy controller 114 is implemented as computer instructions stored on computer-readable storage media and executed by a processor system of the mobile device 102 and/or of the mobile device 104. Alternatively or in addition, the privacy controller 114 is implemented at least partially in hardware of a device.

In one or more implementations, the privacy controller 114 includes independent processing, memory, and/or logic components functioning as a computing and/or electronic device integrated with the mobile device 102 and/or with the mobile device 104. Alternatively or in addition, the privacy controller 114 can be implemented in software, in hardware, or as a combination of software and hardware components. In one or more examples, the privacy controller 114 is implemented as a software application or module, such as executable software instructions (e.g., computer-executable instructions) that are executable with a processor system of the mobile device 102 and/or the mobile device 104 to implement the techniques and features described herein. As a software application or module, the privacy controller 114 is stored on computer-readable storage memory (e.g., memory of a device), or in any other suitable memory device or electronic data storage implemented with the module. Alternatively or in addition, the privacy controller 114 is implemented in firmware and/or at least partially in computer hardware. For example, at least part of the privacy controller 114 is executable by a computer processor, and/or at least part of the privacy controller 114 is implemented in logic circuitry. In at least one implementation the privacy controller 114 can be implemented as part of and/or in conjunction with an operating system of the mobile device 102

As shown, the privacy controller 114 includes a device monitor 116 and a configuration manager 118. In the illustrated example, the privacy controller 114 provides privacy protection functionality for mobile applications based on the operations of the device monitor 116 and/or the configuration manager 118.

In one or more examples, the device monitor 116 detects that encoded account information is generated for display on the mobile device 102. In one or more variations, generation of the encoded account information includes generation of a graphical code, where the graphical code includes at least one of a quick response (QR) code, a bar code, a data matrix, or a universal product code.

In the illustrated example, the mobile device 102 includes a display screen 120. As shown, an application of the device applications 112 that generates QR codes (e.g., a digital payment application) generates a QR code 122, where the QR code 122 represents the encoded account information. In one or more examples, the QR code 122 includes transaction information such as account information for receiving digital payments, amount to be paid, username, user email, and the like.

In one or more examples, the configuration manager 118 captures and stores a record of one or more settings (e.g., one or more privacy-related settings) of the mobile device 102 in response to the device monitor 116 detecting the QR code 122 being generated for display on the display screen 120. In the illustrated example, the one or more settings include at least the Do Not Disturb setting 124.

In one or more implementations, the configuration manager 118 determines a current state of the Do Not Disturb setting 124. The configuration manager 118 determines, based on the capturing, that the one or more settings indicate that the Do Not Disturb setting 124 is off.

In one or more examples, the configuration manager 118 activates the Do Not Disturb setting 124 based on the device monitor 116 detecting that the QR code 122 is generated for display on the display screen 120 and a determination by the configuration manager 118 that the Do Not Disturb setting 124 is off before or at the time the QR code 122 is generated.

In one or more implementations, the configuration manager 118 activating the Do Not Disturb setting 124 can occur in various ways, such as in response to the device monitor 116 detecting the generation of the QR code 122. Additionally or alternatively, the configuration manager 118 activating the Do Not Disturb setting 124 is based on the device monitor 116 determining that the QR code 122 is being displayed on the display screen 120. Additionally or alternatively, the configuration manager 118 activating the Do Not Disturb setting 124 is based on the device monitor 116 determining that the generation of the QR code 122 is associated with finance-related account information. Additionally or alternatively, the configuration manager 118 activating the Do Not Disturb setting 124 is based on the device monitor 116 determining that the generation of the QR code 122 is by a finance-related application (e.g., of the device applications 112). Additionally or alternatively, the configuration manager 118 activating the Do Not Disturb setting 124 is based on the device monitor 116 determining that the generation of the QR code 122 is associated with a payment transaction between the mobile device 102 and the mobile device 104.

In one or more implementations, the privacy controller 114 displays a notification on the display screen 120 of the mobile device 102 indicating that the Do Not Disturb setting 124 is activated. In one or more examples, the privacy controller 114 displays the notification based on the device monitor 116 detecting that the generation of the QR code 122 is associated with the payment transaction between the mobile device 102 and the mobile device 104.

As shown, the mobile device 104 includes a camera 126. In one or more examples, the mobile device 104 scans the payment code (such as QR code 122) via the camera 126. The mobile device 104 decodes the QR code and transmits a payment to the mobile device 102 based on the decoding (e.g., transmits the payment to an account indicated in the QR code).

In one or more implementations, the device monitor 116 detects a dismissal of the QR code 122 from display. For example, the device monitor 116 detects minimizing of the QR code 122 on the display screen 120 so that the QR code 122 is no longer visible. Additionally or alternatively, the device monitor 116 detects when a window displaying the QR code 122 closes, detects an application that generated and/or displayed the QR code 122 closes, detects the mobile device 102 being turned off, and/or detects a lock screen being activated on the display screen 120.

In one or more examples, the configuration manager 118 deactivates the Do Not Disturb setting 124 based on the device monitor 116 detecting the dismissal of the QR code 122. In one or more variations, the configuration manager 118 deactivating the Do Not Disturb setting 124 is based on the device monitor 116 receiving a confirmation from the mobile device 104 that a transaction associated with the QR code 122 is complete.

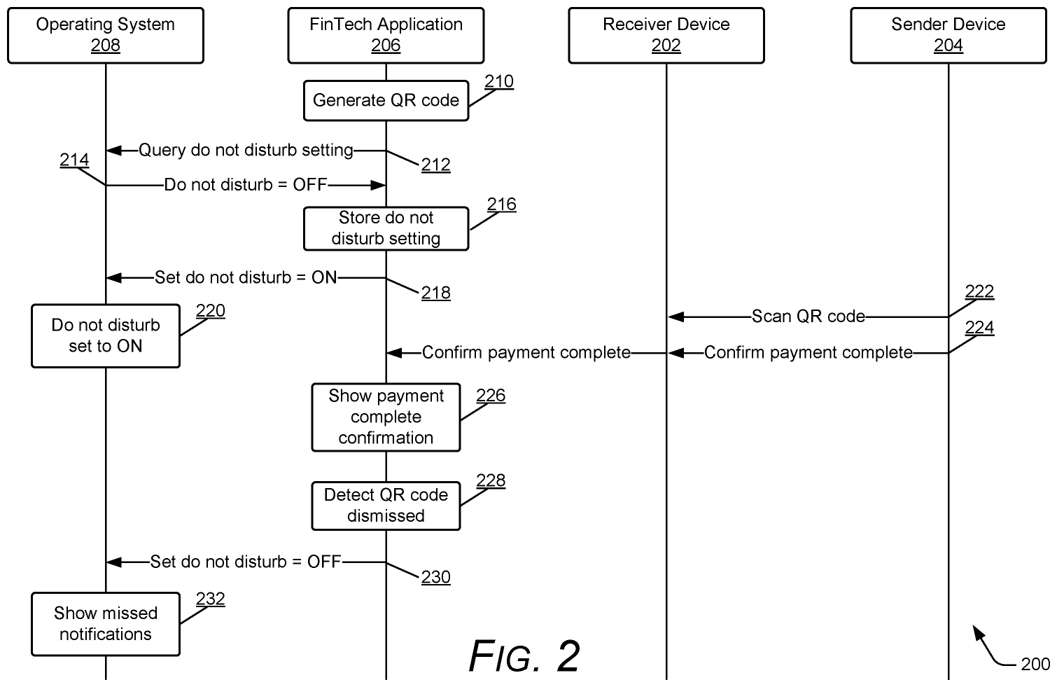

Example methods 200, 300, 400, and 500 are described with reference to respective FIGS. 2, 3, 4, and 5 in accordance with one or more implementations of Do Not Disturb for encoded information, as described herein. Generally, any services, components, modules, managers, controllers, methods, and/or operations described herein can be implemented using software, firmware, hardware (e.g., fixed logic circuitry), manual processing, or any combination thereof. Some operations of the example methods are described in the general context of executable instructions stored on computer-readable storage memory that is local and/or remote to a computer processing system, and one or more implementations include software applications, programs, functions, and the like. Alternatively or in addition, any of the functionality described herein is performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 2 illustrates example swim diagram method(s) 200 for Do Not Disturb for encoded information. The order in which the swim diagram method is described is not intended to be construed as a limitation, and any number or combination of the method operations described herein (e.g., of FIGS. 2, 3, 4, and/or 5) may be performed in any order to perform a method, or an alternate method.

As shown, the swim diagram method 200 includes a receiver device 202 and a sender device 204. In one or more configurations, the receiver device 202 is an example of the mobile device 102 illustrated in FIG. 1. Additionally or alternatively, the sender device 204 is an example of the mobile device 104 illustrated in FIG. 1. In one or more examples, the receiver device 202 is configured to receive a digital payment and the sender device 204 is configured to send the digital payment. As shown, the receiver device 202 includes a transaction application 206 and the privacy controller 114. As mentioned above the privacy controller 114 can be implemented as part of and/or in conjunction with an operating system of the receiver device 202.

At 210, the transaction application 206 generates a payment code (such as a QR code). For example, the transaction application 206 receives a command to generate a QR code in relation to a digital payment. Accordingly, the transaction application 206 generates a QR code that encodes financial account information and/or an amount of the digital payment.

At 212, the transaction application 206 queries the privacy controller 114 for the status of the Do Not Disturb setting. For example, in response to the generation of the QR code at 210, the transaction application 206 queries the privacy controller 114 for the device settings of the receiver device 202.

At 214, the privacy controller 114 responds to the query with the status of the Do Not Disturb setting. For example, the privacy controller 114 sends a reply to the transaction application 206 where the reply includes the current status of the Do Not Disturb setting for the receiver device 202. As shown, in this example the privacy controller 114 responds that the Do Not Disturb setting of the receiver device is OFF (i.e., Do Not Disturb currently deactivated).

At 216, the privacy controller 114, in conjunction with the transaction application 206, stores the current Do Not Disturb setting. For example, the transaction application 206 stores the Do Not Disturb setting in a storage device of the receiver device 202 (e.g., a storage device with reference to the example device shown in FIG. 6).

At 218, the transaction application 206 sends a command to the privacy controller 114 to set the Do Not Disturb setting to ON. For example, based on the response at 214, the transaction application 206 determines that the current Do Not Disturb setting of the receiver device is OFF. In response to the determination that the current Do Not Disturb setting of the receiver device is OFF, the transaction application 206 instructs the privacy controller 114 to activate the Do Not Disturb setting for the receiver device 202 (e.g., to turn on Do Not Disturb).

At 220, the privacy controller 114, such as in conjunction with an operating system, sets Do Not Disturb to ON. For example, the privacy controller 114 receives the instruction at 218 and then turns on Do Not Disturb for the receiver device 202. The privacy controller 114, for instance, can mute notifications of the receiver device 202 while the Do Not Disturb setting is set to ON.

At 222, the sender device 204 scans the QR code. For example, the sender device 204 uses a camera (e.g., the camera 126) to scan the QR code generated at 210. In one or more examples, the sender device 204 uses a camera in conjunction with a transaction application installed on the sender device 204.

At 224, the sender device 204 confirms the payment is complete. For example, the sender device 204 captures the QR code at 222, decodes financial account information and payment amount from the QR code, transmits the requested payment to the indicated bank account, and sends a payment confirmation message to the receiver device 202.

At 226, the transaction application 206 shows a payment complete confirmation. For example, the transaction application 206 receives the payment complete confirmation at 224 and shows a message on the screen of the receiver device 202 that indicates the payment is complete.

At 228, the privacy controller 114 detects that the QR code is dismissed. For example, the transaction application 206 detects that an active window showing the QR code on the screen of the receiver device 202 is closed.

At 230, the transaction application 206 sends a command to the privacy controller 114 to set the Do Not Disturb setting to OFF. For example, based on the detection of the QR code being dismissed at 228, the transaction application 206 sends the command to the privacy controller 114 to set the Do Not Disturb setting to OFF. In one or more examples the transaction application 206 queries the Do Not Disturb setting saved at 216 to confirm that the saved Do Not Disturb setting is “Do Not Disturb=OFF.” Accordingly, the transaction application 206 instructs the privacy controller 114 to deactivate the Do Not Disturb setting for the receiver device 202 (e.g., to turn off Do Not Disturb).

At 232, the privacy controller 114 can cause missed notifications to be presented. For example, the privacy controller 114 mutes notifications while the Do Not Disturb setting is set to ON, and once the Do Not Disturb setting is set to OFF at 230, the privacy controller 114 such as in conjunction with an operating system causes notifications that were muted to be presented via the receiver device 202.

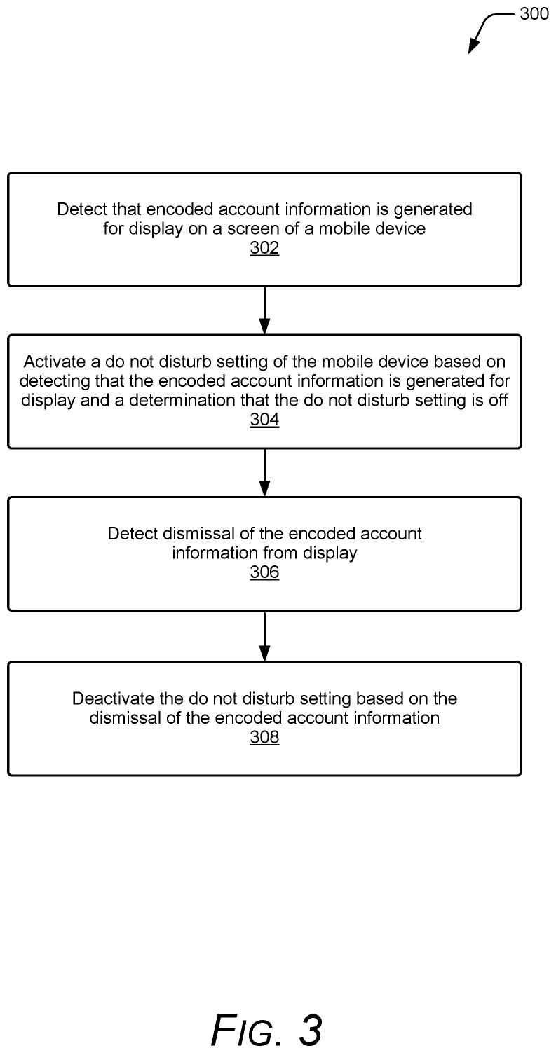

FIG. 3 illustrates example method(s) 300 for Do Not Disturb for encoded information. The order in which the method is described is not intended to be construed as a limitation, and any number or combination of the method operations described herein (e.g., of FIGS. 2, 3, 4, and/or 5) may be performed in any order to perform a method, or an alternate method.

At 302, the method 300 includes detecting that encoded account information is generated for display on a screen of a mobile device. For example, the privacy controller 114 detects that QR code 122 is generated for display on the display screen 120 of the mobile device 102.

At 304, the method 300 includes activating a Do Not Disturb setting of the mobile device based on detecting that the encoded account information is generated for display and a determination that the Do Not Disturb setting is off. For example, the privacy controller 114 activates the Do Not Disturb setting 124 (e.g., turns on Do Not Disturb) based on the privacy controller 114 detecting that the QR code 122 is generated for display and determining that the Do Not Disturb setting 124 is set to off.

At 306, the method 300 includes detecting dismissal of the encoded account information from display. For example, the privacy controller 114 monitors the active view of the QR code 122 to determine whether the QR code 122 continues to be displayed or is no longer being displayed on the display screen 120. Based on the monitoring, the privacy controller 114 detects that the QR code 122 is no longer being displayed on the display screen 120.

At 308, the method 300 includes deactivating the Do Not Disturb setting based on the dismissal of the encoded account information. For example, the privacy controller 114 deactivates the Do Not Disturb setting 124 (e.g., turns off Do Not Disturb) based on the privacy controller 114 detecting that the QR code 122 is no longer being displayed on the display screen 120.

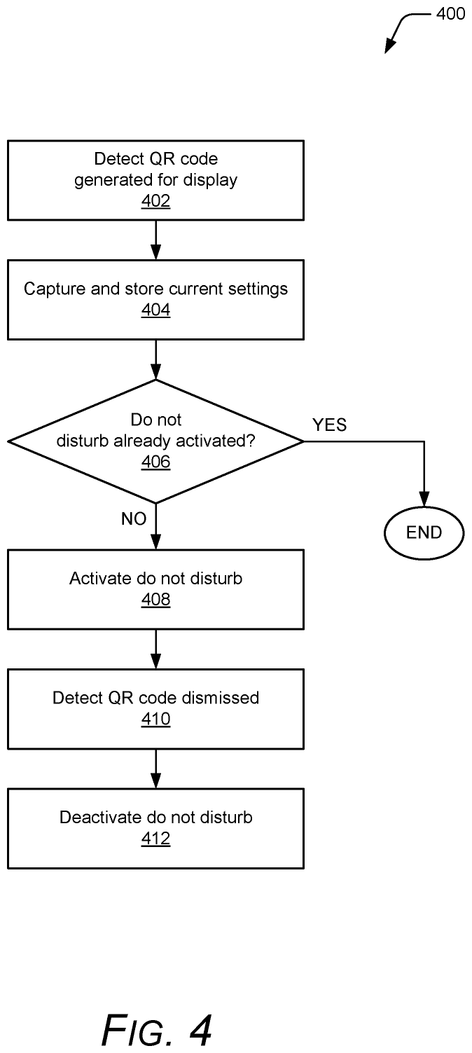

FIG. 4 illustrates example method(s) 400 for Do Not Disturb for encoded information. The order in which the method is described is not intended to be construed as a limitation, and any number or combination of the method operations described herein (e.g., of FIGS. 2, 3, 4, and/or 5) may be performed in any order to perform a method, or an alternate method.

At 402, the method 400 includes detecting a payment/account information code (such as QR code) generated for display. For example, the privacy controller 114 detects a QR code being generated for display on the mobile device 102.

At 404, the method 400 includes capturing and storing current device settings. For example, the privacy controller 114 captures and stores one or more device settings of the mobile device 102.

At 406, the method 400 includes determining whether Do Not Disturb is already activated. For example, the privacy controller 114 analyzes the current device setting of the mobile device 102 and determines whether the current device settings indicate that the Do Not Disturb setting of the mobile device 102 is ON or OFF. When the privacy controller 114 determines that the Do Not Disturb setting of the mobile device 102 is ON, the method 400 ends. When the privacy controller 114 determines that the Do Not Disturb setting of the mobile device 102 is OFF, the method 400 proceeds to 408.

At 408, the method 400 includes activating the Do Not Disturb setting. For example, when the privacy controller 114 determines that the Do Not Disturb setting of the mobile device 102 is OFF, the privacy controller 114 activates the Do Not Disturb setting of the mobile device 102.

At 410, the method 400 includes detecting the QR code is dismissed. For example, the privacy controller 114 monitors the display of the QR code after the QR code is generated at 402. Based on the monitoring, the privacy controller 114 determines that the QR code is dismissed (e.g., detect active window displaying the QR code is closed).

At 412, the method 400 includes deactivating the Do Not Disturb setting. For example, when the privacy controller 114 determines that the QR code is dismissed, the privacy controller 114 turns the Do Not Disturb setting off (e.g., reverts back to the original Do Not Disturb setting of the mobile device 102 before the QR code was generated).

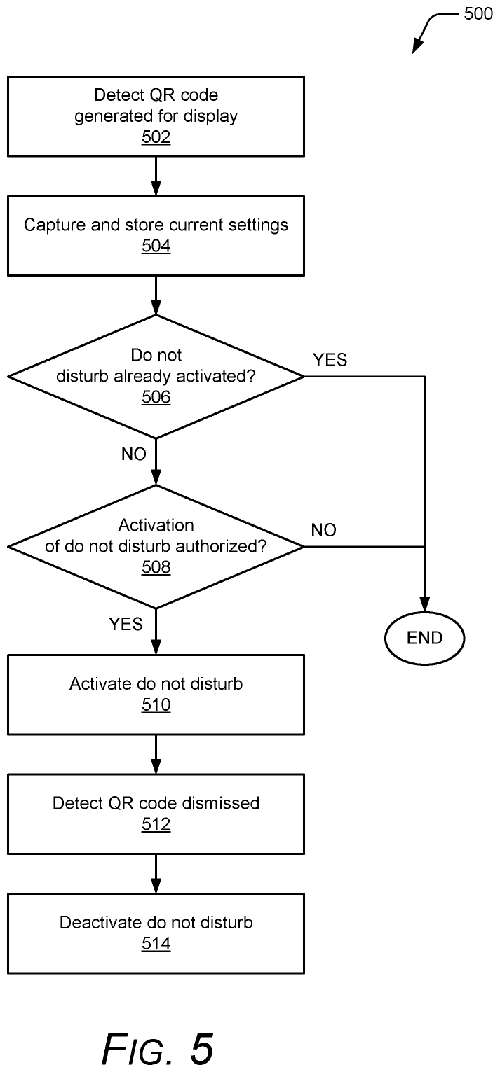

FIG. 5 illustrates example method(s) 500 for Do Not Disturb for encoded information. The order in which the method is described is not intended to be construed as a limitation, and any number or combination of the method operations described herein (e.g., of FIGS. 2, 3, 4, and/or 5) may be performed in any order to perform a method, or an alternate method.

At 502, the method 500 includes detecting a QR code generated for display. For example, the privacy controller 114 monitors for generation of QR codes (e.g., monitors transaction applications of the mobile device 102) and detects a QR code being generated based on the monitoring.

At 504, the method 500 includes capturing and storing current device settings. For example, the privacy controller 114 queries the device settings of the mobile device 102 and stores the current device settings in a storage of the mobile device 102.

At 506, the method 500 includes determining whether Do Not Disturb is already activated. For example, the privacy controller 114 analyzes the current device setting of the mobile device 102 and determines whether the current device settings indicate that the Do Not Disturb setting of the mobile device 102 is ON or OFF. When the privacy controller 114 determines that the Do Not Disturb setting of the mobile device 102 is ON, the method 500 ends. When the privacy controller 114 determines that the Do Not Disturb setting of the mobile device 102 is OFF, the method 500 proceeds to 508.

At 508, the method 500 determines whether activation of the Do Not Disturb setting is authorized. For example, the privacy controller 114 generates a prompt requesting authorization of the activation of the Do Not Disturb setting and displays the prompt on a screen of the mobile device 102. In one or more examples, the prompt includes a request message (e.g., “Allow activation of the Do Not Disturb setting?”), a first selectable control to allow activation of the Do Not Disturb setting, and/or a second selectable control to deny activation of the Do Not Disturb setting. When the privacy controller 114 determines authorization is denied (e.g., receiving input denying authorization in response to the prompt), the method 500 ends. When the privacy controller 114 determines authorization is approved, the method 500 proceeds to 510.

At 510, the method 500 includes activating the Do Not Disturb setting. For example, when the privacy controller 114 determines that the Do Not Disturb setting of the mobile device 102 is OFF, the privacy controller 114 activates the Do Not Disturb setting of the mobile device 102.

At 512, the method 500 includes detecting the QR code is dismissed. For example, the privacy controller 114 monitors the display of the QR code after the QR code is generated at 502. Based on the monitoring, the privacy controller 114 determines that the QR code is dismissed (e.g., detect active window displaying the QR code is closed).

At 514, the method 500 includes deactivating the Do Not Disturb setting. For example, when the privacy controller 114 determines that the QR code is dismissed, the privacy controller 114 turns the Do Not Disturb setting off (e.g., reverts back to the original Do Not Disturb setting of the mobile device 102 before the QR code was generated). Accordingly, any missed notifications and/or future notifications are displayed on a screen of the mobile device 102.

FIG. 6 illustrates various components of an example device 600, which can implement aspects of the techniques and features for Do Not Disturb for encoded information, as described herein. The example device 600 may be implemented as any of the devices described with reference to the previous FIGS. 1-5, such as any type of a wireless device, mobile device, mobile phone, flip phone, client device, companion device, paired device, display device, tablet, computing, communication, entertainment, gaming, media playback, and/or any other type of computing and/or electronic device. For example, the mobile device 102 and/or the mobile device 104 described with reference to FIGS. 1-5 may be implemented as the example device 600.

The example device 600 can include various, different communication devices 602 that enable wired and/or wireless communication of device data 604 with other devices. The device data 604 can include any of the various device data and content that is generated, processed, determined, received, stored, and/or communicated from one computing device to another. In one or more examples, the device data 604 includes at least one of a graphical code (e.g., the QR code 122) generated by a mobile device or captured by a mobile device (e.g., captured via the camera 126 of the mobile device 104), device configuration data (e.g., device settings such as the Do Not Disturb setting), or a captured record of one or more settings of a mobile device that includes at least a Do Not Disturb setting. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable mobile devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage mobile device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal processing- and control module, code that is specific to a particular device, a hardware abstraction layer for a particular device, and so on.

In one or more examples, the device 600 includes a privacy controller 618 that implements various aspects of the described features and techniques described herein. The privacy controller 618 is implemented with hardware components and/or in software as one of the device applications 614, such as when the example device 600 is implemented as the mobile device 102 and/or the mobile device 104 described with reference to FIGS. 1-5. An example of the privacy controller 618 is the privacy controller 114 implemented by the mobile device 102 and/or the mobile device 104, such as a software application and/or as hardware components in the mobile device 102 and/or in the mobile device 104. In implementations, the privacy controller 618 includes independent processing, memory, and logic components as a computing and/or electronic device integrated with the example device 600.

The example device 600 can also include a microphone 620 (e.g., to capture an audio recording of a user) and/or camera devices 622 (e.g., to capture video images of the user during a call), as well as motion sensors 624, such as may be implemented as components of an inertial measurement unit (IMU). The motion sensors 624 may be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632 (e.g., for display of the QR code 122). The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for Do Not Disturb for encoded information have been described in language specific to features and/or methods, the appended claims are not necessarily limited to the specific features or methods described. Rather, the specific features and methods are disclosed as example implementations for Do Not Disturb for encoded information, and other equivalent features and methods are intended to be within the scope of the appended claims. Further, various examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a mobile device including: at least one memory, and at least one processor coupled to the at least one memory and configured to cause the mobile device to: detect that encoded account information is generated for display on a screen of the mobile device, activate a Do Not Disturb setting of the mobile device based on detecting that the encoded account information is generated for display and a determination that the Do Not Disturb setting is off, detect dismissal of the encoded account information from display, and deactivate the Do Not Disturb setting based on the dismissal of the encoded account information.

In some aspects, the techniques described herein relate to a mobile device, wherein activation of the Do Not Disturb setting is in response to the at least one processor causing the mobile device to detect the generation of the encoded account information.

In some aspects, the techniques described herein relate to a mobile device, wherein activation of the Do Not Disturb setting is based on the at least one processor causing the mobile device to determine that the generation of the encoded account information is associated with finance-related account information.

In some aspects, the techniques described herein relate to a mobile device, wherein activation of the Do Not Disturb setting is based on the at least one processor causing the mobile device to determine that the generation of the encoded account information is by a finance-related application.

In some aspects, the techniques described herein relate to a mobile device, wherein activation of the Do Not Disturb setting is based on the at least one processor causing the mobile device to determine that the generation of the encoded account information is associated with a payment transaction between the mobile device and another mobile device.

In some aspects, the techniques described herein relate to a mobile device, wherein the at least one processor causes the mobile device to display a visual prompt on the screen of the mobile device indicating that the Do Not Disturb setting is activated based on the generation of the encoded account information being associated with the payment transaction between the mobile device and another mobile device.

In some aspects, the techniques described herein relate to a mobile device, wherein the determination that the Do Not Disturb setting is off is based on the at least one processor causing the mobile device to: capture and store a record of one or more settings of the mobile device that includes at least the Do Not Disturb setting, and determine, based on the capturing, that the one or more settings indicate that the Do Not Disturb setting is off.

In some aspects, the techniques described herein relate to a mobile device, wherein generation of the encoded account information is based on the at least one processor causing the mobile device to generate a graphical code that includes at least one of a quick response (QR) code, a bar code, a data matrix, or a universal product code.

In some aspects, the techniques described herein relate to a mobile device, wherein deactivation of the Do Not Disturb setting is based on is based on the at least one processor causing the mobile device to receive a confirmation from another mobile device that a transaction associated with the encoded account information is complete.

In some aspects, the techniques described herein relate to a method including: detecting that encoded account information is generated for display on a screen of a mobile device, activating a Do Not Disturb setting of the mobile device based on detecting that the encoded account information is generated for display and a determination that the Do Not Disturb setting is off, detecting dismissal of the encoded account information from display, and deactivating the Do Not Disturb setting based on the dismissal of the encoded account information.

In some aspects, the techniques described herein relate to a method, wherein activating the Do Not Disturb setting is in response to detecting the generation of the encoded account information.

In some aspects, the techniques described herein relate to a method, wherein activating the Do Not Disturb setting is based on determining that the generation of the encoded account information is associated with finance-related account information.

In some aspects, the techniques described herein relate to a method, wherein activating the Do Not Disturb setting is based on determining that the generation of the encoded account information is by a finance-related application.

In some aspects, the techniques described herein relate to a method, wherein activating the Do Not Disturb setting is based on determining that the generation of the encoded account information is associated with a payment transaction between the mobile device and another mobile device.

In some aspects, the techniques described herein relate to a method, further including displaying a visual cue on the screen of the mobile device indicating that the Do Not Disturb setting is activated based on the generation of the encoded account information being associated with the payment transaction between the mobile device and another mobile device.

In some aspects, the techniques described herein relate to a method, wherein the determination that the Do Not Disturb setting is off is based on: capturing and storing a record of one or more settings of the mobile device that includes at least the Do Not Disturb setting, and determining, based on the capturing, that the one or more settings indicate that the Do Not Disturb setting is off.

In some aspects, the techniques described herein relate to a system including: a display device, an application executing on a mobile device, and a privacy controller configured to control aspects of mobile application user privacy protection, the privacy controller implemented at least partially in computer hardware to: detect that encoded account information is generated by the application for display on the display device, activate a Do Not Disturb setting of the mobile device based on detecting that the encoded account information is generated for display, a determination that the Do Not Disturb setting is off, and detecting an approval in response to a prompt shown on the display device, detect dismissal of the encoded account information from display on the display device, and deactivate the Do Not Disturb setting based on the dismissal of the encoded account information.

In some aspects, the techniques described herein relate to a system, wherein activation of the Do Not Disturb setting is in response to the privacy controller being implemented at least partially in the computer hardware to detect the generation of the encoded account information.

In some aspects, the techniques described herein relate to a system, wherein activation of the Do Not Disturb setting is based on the privacy controller being implemented at least partially in the computer hardware to determine that the generation of the encoded account information is associated with finance-related account information.

In some aspects, the techniques described herein relate to a system, wherein activation of the Do Not Disturb setting is based on to the privacy controller being implemented at least partially in the computer hardware to determine that the application is a finance-related application.

1. A mobile device comprising:
at least one memory; and
at least one processor coupled to the at least one memory and configured to cause the mobile device to:
detect that encoded account information is generated for display on a screen of the mobile device;
activate a Do Not Disturb setting of the mobile device based on detecting that the encoded account information is generated for display and a determination that the Do Not Disturb setting is off;
detect dismissal of the encoded account information from display; and
deactivate the Do Not Disturb setting based on the dismissal of the encoded account information.

2. The mobile device of claim 1, wherein activation of the Do Not Disturb setting is in response to the at least one processor causing the mobile device to detect the generation of the encoded account information.

3. The mobile device of claim 1, wherein activation of the Do Not Disturb setting is based on the at least one processor causing the mobile device to determine that the generation of the encoded account information is associated with finance-related account information.

4. The mobile device of claim 1, wherein activation of the Do Not Disturb setting is based on the at least one processor causing the mobile device to determine that the generation of the encoded account information is by a finance-related application.

5. The mobile device of claim 1, wherein activation of the Do Not Disturb setting is based on the at least one processor causing the mobile device to determine that the generation of the encoded account information is associated with a payment transaction between the mobile device and another mobile device.

6. The mobile device of claim 5, wherein the at least one processor causes the mobile device to display a visual prompt on the screen of the mobile device indicating that the Do Not Disturb setting is activated based on the generation of the encoded account information being associated with the payment transaction between the mobile device and another mobile device.

7. The mobile device of claim 1, wherein the determination that the Do Not Disturb setting is off is based on the at least one processor causing the mobile device to:
capture and store a record of one or more settings of the mobile device that includes at least the Do Not Disturb setting; and
determine, based on the capturing, that the one or more settings indicate that the Do Not Disturb setting is off.

8. The mobile device of claim 1, wherein generation of the encoded account information is based on the at least one processor causing the mobile device to generate a graphical code that includes at least one of a quick response (QR) code, a bar code, a data matrix, or a universal product code.

9. The mobile device of claim 1, wherein deactivation of the Do Not Disturb setting is based on is based on the at least one processor causing the mobile device to receive a confirmation from another mobile device that a transaction associated with the encoded account information is complete.

10. A method comprising:
detecting that encoded account information is generated for display on a screen of a mobile device;
activating a Do Not Disturb setting of the mobile device based on detecting that the encoded account information is generated for display and a determination that the Do Not Disturb setting is off;
detecting dismissal of the encoded account information from display; and
deactivating the Do Not Disturb setting based on the dismissal of the encoded account information.

11. The method of claim 10, wherein activating the Do Not Disturb setting is in response to detecting the generation of the encoded account information.

12. The method of claim 10, wherein activating the Do Not Disturb setting is based on determining that the generation of the encoded account information is associated with finance-related account information.

13. The method of claim 10, wherein activating the Do Not Disturb setting is based on determining that the generation of the encoded account information is by a finance-related application.

14. The method of claim 10, wherein activating the Do Not Disturb setting is based on determining that the generation of the encoded account information is associated with a payment transaction between the mobile device and another mobile device.

15. The method of claim 14, further comprising displaying a visual cue on the screen of the mobile device indicating that the Do Not Disturb setting is activated based on the generation of the encoded account information being associated with the payment transaction between the mobile device and another mobile device.

16. The method of claim 10, wherein the determination that the Do Not Disturb setting is off is based on:
capturing and storing a record of one or more settings of the mobile device that includes at least the Do Not Disturb setting; and
determining, based on the capturing, that the one or more settings indicate that the Do Not Disturb setting is off.

17. A system comprising:
a display device;
an application executing on a mobile device; and
a privacy controller configured to control aspects of mobile application user privacy protection, the privacy controller implemented at least partially in computer hardware to:
detect that encoded account information is generated by the application for display on the display device;
activate a Do Not Disturb setting of the mobile device based on detecting that the encoded account information is generated for display, a determination that the Do Not Disturb setting is off, and detecting an approval in response to a prompt shown on the display device;
detect dismissal of the encoded account information from display on the display device; and
deactivate the Do Not Disturb setting based on the dismissal of the encoded account information.

18. The system of claim 17, wherein activation of the Do Not Disturb setting is in response to the privacy controller being implemented at least partially in the computer hardware to detect the generation of the encoded account information.

19. The system of claim 17, wherein activation of the Do Not Disturb setting is based on the privacy controller being implemented at least partially in the computer hardware to determine that the generation of the encoded account information is associated with finance-related account information.

20. The system of claim 17, wherein activation of the Do Not Disturb setting is based on to the privacy controller being implemented at least partially in the computer hardware to determine that the application is a finance-related application.
